(19) United States
(12) Patent Application Publication
(10) Pub. No.: US 2012/0294125 A1
(43) Pub. Date: Nov. 22, 2012

(54) ASTRONOMICAL CLOCK

(76) Inventor: Luc Laramee, St-Severin de Proulxville (CA)

(21) Appl. No.: 13/512,342

(22) PCT Filed: Nov. 29, 2010
(86) PCT No.: PCT/CA10/01909

§ 371 Date: Aug. 8, 2012

Related U.S. Application Data
(60) Provisional application No. 61/272,977, filed on Nov. 27, 2009.

(51) Int. Cl. G04B 19/26

(52) U.S. Cl. 368/17; 368/15

(57) ABSTRACT

An astronomical clock, comprising a first and second celestial body representations, a displacement mechanism operatively connected to the second celestial body representation, the displacement mechanism displacing the second celestial body representation around the first celestial body representation along an ellipsoidal trajectory an a first set of time scale indicators positioned along the ellipsoid trajectory. The displacement mechanism displaces the second celestial body representation around the first celestial body representation at a speed proportional to the revolution of the second celestial body around the first celestial body, the position of the second celestial body representation with respect to the first set of time scale indicators indicating a time period corresponding to the positioning of the second celestial body.

### TECHNICAL FIELD

The present invention relates to an astronomical clock.

### BACKGROUND

Astronomical clocks are apparatuses that show, in addition to the time of day, astronomical information. This may include the location of the sun and moon in the sky, the age and phase of the moon, the position of the sun on the ecliptic and the current zodiac sign, the sidereal time, and other astronomical data such as the moon's nodes (for indicating eclipses) or a rotating star map. Astronomical clocks usually represent the solar system using the geocentric model. The center of a dial marked with a disc or sphere representing the earth, located at the center of the solar system. The sun is often represented by a golden sphere, shown rotating around the earth once a day around a 24 hour analog dial.

### SUMMARY

In accordance with the present invention, there is provided an astronomical clock, comprising:
a first and second celestial body representations;
a displacement mechanism operatively connected to the first and second celestial body representations, the displacement mechanism displacing the second celestial body representation around the first celestial body representation along an ellipsoidal trajectory; and
a first set of time scale indicators positioned along the ellipsoid trajectory;
   wherein the displacement mechanism displaces the second celestial body representation around the first celestial body representation at a speed proportional to the revolution of the second celestial body around the first celestial body, the position of the second celestial body representation with respect to the first set of time scale indicators indicating a time period corresponding to the positioning of the second celestial body.

### BRIEF DESCRIPTION OF THE FIGURES

Embodiments of the invention will be described by way of example only with reference to the accompanying drawings, in which:

FIG. 1 is a top plan view of the astronomical clock in accordance with an illustrative embodiment of the present invention;

FIG. 2 is a side view of the astronomical clock of FIG. 1;

FIG. 3 is a cross sectional view of the astronomical clock along axis III-III of FIG. 2; and

FIG. 4 shows an example of a step motor assembly.

### DETAILED DESCRIPTION

Generally stated, the non-limitative illustrative embodiment of the present invention provides an astronomical clock that gives the time, day, month and season using a synchronized mechanical simulation of the earth revolving around the sun. The astronomical clock can be used as both an informational tool and a work of art in public spaces such as airports, convention centers and museums, and may also be used as an educational tool.

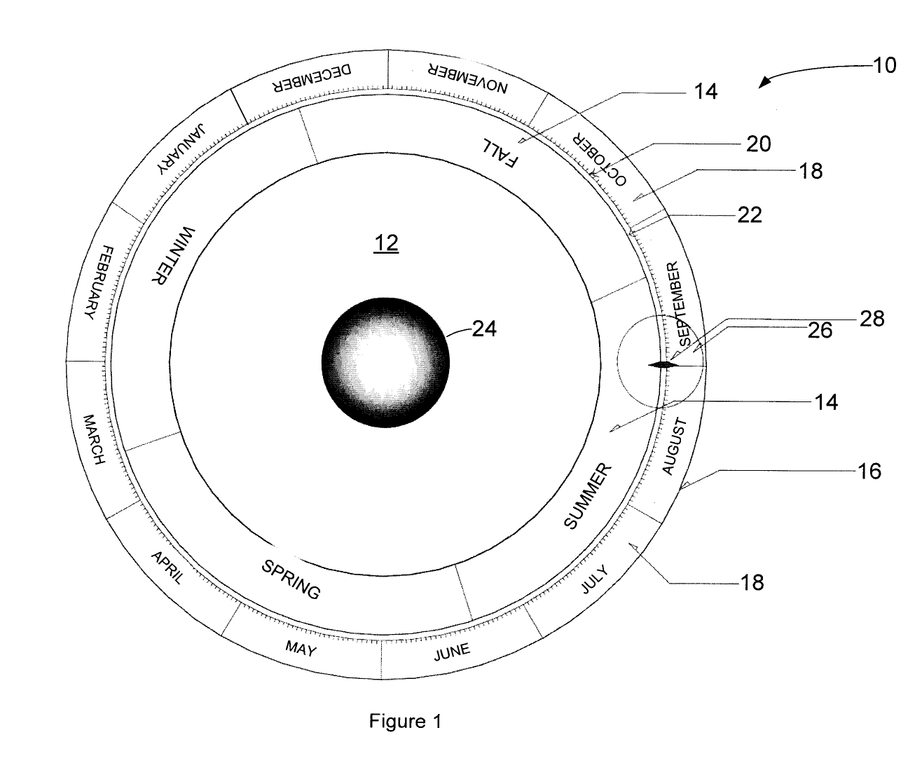

Referring to FIG. 1, there is shown a top plan view of the astronomical clock 10 which comprises two concentric circular plateaus, a fixed plateau 12 and an adjustable plateau 16 separated by a slot 22. The fixed plateau 12 is separated in four zones 14 representing the four seasons. Optionally, the fixed plateau 12 may have further zones, for example twelve zones representing the signs of the zodiac (not shown). The adjustable plateau 16 is separated in twelve zones 18 representing the twelve months and its internal circumference 20 marked with the days for each month. The adjustable plateau 16 can be automatically, using an adjustment mechanism, or manually adjusted every four years in order to account for the bissextile years of our calendar. Above the center of the fixed plateau 12, i.e. the center of the astronomical clock 10, is positioned a luminous sphere 24 representing the sun around which revolves another sphere 26 representing the earth.

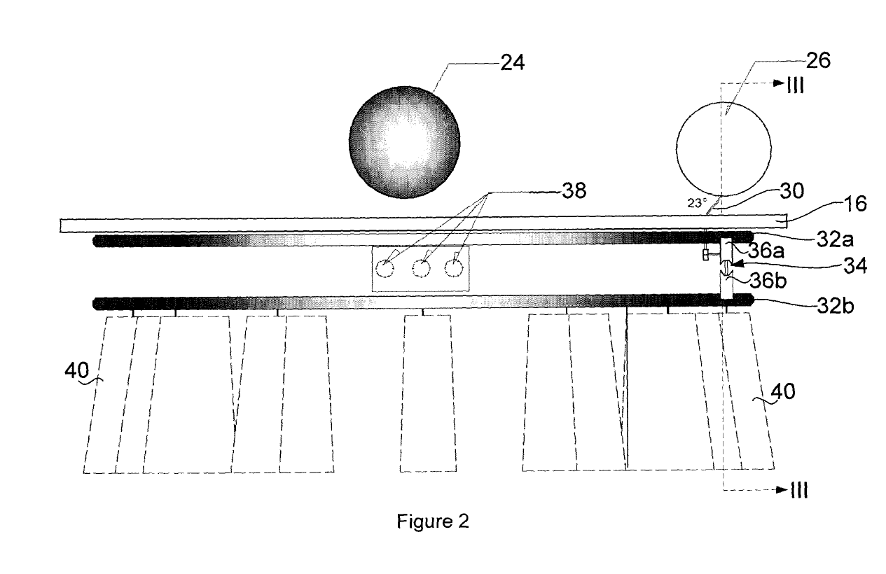

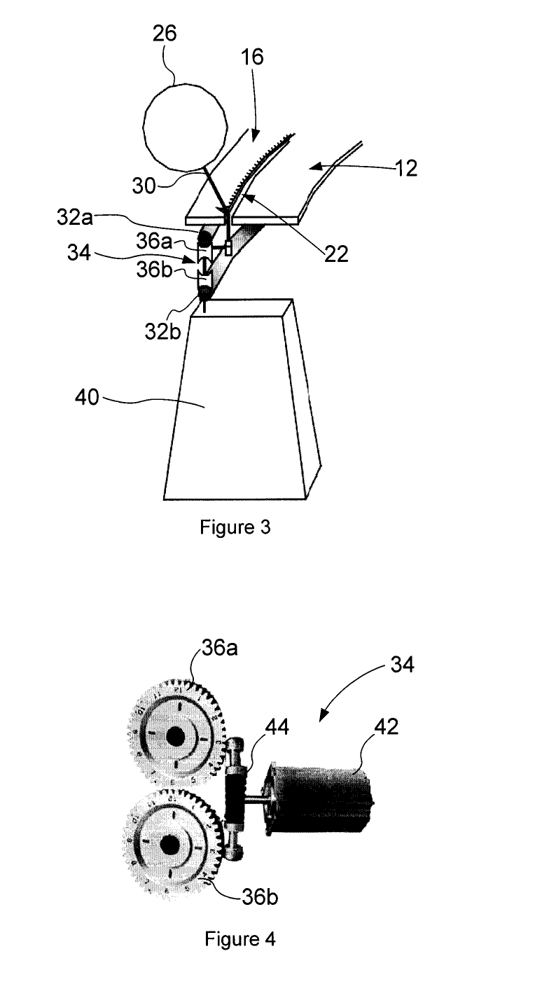

Referring now to FIG. 2, the earth sphere 26 is connected to a displacement mechanism in the form of a step motor assembly 34 via a support member 30 passing through the slot 22 between the fixed 12 and adjustable 16 plateaus. A cursor 28 (best seen in FIG. 1) is attached to the support member 30 in order to indicate the day, month and season associated with the position of the earth sphere 26 on the astronomical clock 10 by pointing at corresponding days and zones representative of the month and season. The earth sphere 26 is pivotally connected to the support member 30 so as to allow it to revolve 360 degrees around its central axis which is inclined by about 23 degrees to represent the inclination of the earth.

The step motor assembly 34 is movably engaged to a pair of rails 32a and 32b through wheels 36a and 36b, respectively. The rails 32a, 32b, follow the slot 22 so as to move the earth sphere 26 around the sun sphere 24 to simulate, in real time, the movement of the earth around the sun. The astronomical clock 10 further comprises a control panel 38 operating a controller 39 in order to, for example, set the astronomical clock 10 to a specific time/date, set the speed of the astronomical clock 10, adjust illumination settings, etc., and is supported by a base formed by, for example, a plurality of pillars 40. The pillars 40 may be purely functional or may optionally be stylistically designed to represent, for example, the months, the signs of the zodiac or any other desired representation. The internal workings of the astronomical clock 10, e.g. rails 32a, 32b and step motor assembly 34, may be left visible or hidden by some form of body work.

In an alternative embodiment, the rails 32a, 32b and step motor assembly 34 may be replaced with another form of mechanism, for example a rotating plateau actuated by an hydraulic system.

Referring to FIG. 4, there is shown an example of a step motor assembly 34 including wheels 36a and 36b connected to an electrical motor 42 through transmission 44.

The earth sphere 26 may be made, for example, of glass with a light source within and a movable parabolic dark screen on its inner surface, the screen being configured and connected to the earth sphere 26 and/or support member 30 so as to remain on a side opposed to the sun sphere 24 in order to simulate nighttime. The earth sphere 26 also includes an actuator, for example an electric motor (not shown), that rotates the earth sphere 26 around its axis to simulate, in real time, the rotation of the earth. An indicator, for example a flashing led or other source of light, indicates the position of the astronomical clock 10 on the earth. In an alternative embodiment a plurality of indicators, for example a matrix of led's, may be used to indicate the present location of the astronomical clock, locations of monuments, natural disasters, other astronomical clocks, a sponsor's locations, etc. In another alternative embodiment, the actuator used to rotate the earth sphere 26 may be located on the support member 30 or on the step motor assembly 34.

In a further alternative embodiment, the earth sphere 26 and/or sun sphere 24 may be in the form of a sphere with projectors projecting the image of the celestial body, for example a digital video globe. It is to be understood that the earth and sun may be replaced with other celestial bodies. It is also to be understood that in the case where a digital video globe is used, the movable parabolic dark screen, actuator and indicators may be replaced by video images.

The controller 39, which is operated by the control panel 38 and, optionally, by a remote controller or computer through a remote access interface such as, for example, an Internet connection, manages and synchronizes the movements of the various components of the astronomical clock 10 such as, for example, the displacement mechanism, the actuator and, optionally, the adjustment mechanism. More specifically, the control system insures that the earth sphere 26 revolves around the sun such that the cursor 28 attached to the support member 30 indicates the correct day, month and season, that a complete revolution of the earth sphere 26 takes 24 hours and, optionally, that the movable parabolic dark screen of the earth sphere 26 remains on the side opposed to the sun sphere 24 in order to simulate nighttime. In the alternative embodiment where the earth sphere 26 includes a plurality of indicators, the control system may also control the selective activation of the indicators in response to events or to provide information.

Complementary to the astronomical clock 10, models of monuments or buildings may be disposed around, or in a room adjacent, the astronomical clock 10 and provided with a lighting system controlled by the control system of the astronomical clock 10 so as to simulate the real-life illumination of each monument or building in accordance with the time, day and month indicated by the astronomical clock 10. Furthermore, the ceiling where the astronomical clock 10 is located, or an adjacent room containing the models of monuments or buildings, may be provided with a lighting system, such as a matrix of led's, controlled by the control system of the astronomical clock 10 so as to simulate the real-life celestial vault in accordance with the time, day and month indicated by the astronomical clock 10.

In an alternative embodiment of the astrological clock the sun and earth may be replaced by other celestial bodies. In another alternative embodiment other planets and/or moons may be added to the astronomical clock. In a further alternative embodiment the astronomical clock may represent a different galaxy or represent different configurations of celestial bodies. It is to be understood that in the various alternative embodiments the days, months and seasons will be adjusted or replaced with appropriate time measurement units or time scale divisions/indicators depending on the celestial bodies depicted.

Although the present invention has been described by way of particular embodiments and examples thereof, it should be noted that it will be apparent to persons skilled in the art that modifications may be applied to the present particular embodiment without departing from the scope of the present invention.

1. An astronomical clock, comprising:
a first and second celestial body representations;
a displacement mechanism operatively connected to the second celestial body representation, the displacement mechanism displacing the second celestial body representation around the first celestial body representation along an ellipsoidal trajectory; and
a first set of time scale indicators positioned along the ellipsoid trajectory;
wherein the displacement mechanism displaces the second celestial body representation around the first celestial body representation at a speed proportional to the revolution of the second celestial body around the first celestial body, the position of the second celestial body representation with respect to the first set of time scale indicators indicating a time period corresponding to the positioning of the second celestial body.

2. The astronomical clock of claim 1, wherein the first set of time scale indicator's are days.

3. The astronomical clock of claim 2, further comprising a second set of time scale indicators.

4. The astronomical clock of claim 3, wherein the second set of time scale indicators are months.

5. The astronomical clock of claim 1, further comprising a third set of time scale indicators.

6. The astronomical clock of claim 5, wherein the third set of time scale indicators are seasons.

7. The astronomical clock of claim 5, wherein the first and second sets of time scale indicators are positioned on an adjustable plateau.

8. The astronomical clock of claim 6, wherein the first and second sets of time scale indicators are positioned on an adjustable plateau and the third set of time scale indicators are positioned on a fixed plateau concentric with the adjustable plateau.

9. The astronomical clock of claim 7, wherein the adjustable plateau includes an adjustment mechanism to adjust the position of the first and second sets of time scale indicators to account for bissextile years.

10. The astronomical clock of claim 1, wherein the second celestial body representation includes a movable parabolic dark screen configured so as to remain on a side opposed to the first celestial body representation.

11. The astronomical clock of claim 1, wherein the second celestial body representation includes one or more location indicators.

12. The astronomical clock of claim 11, wherein the one or more location indicators indicate a location selected from a group consisting of a monument, a natural disaster, the astronomical clock, another astronomical clock and a sponsor.

13. The astronomical clock of claim 1, wherein the first and second celestial body representations are digital video globes.

14. The astronomical clock of claim 1, wherein the second celestial body representation is operatively connected to the displacement mechanism via a support member having a cursor pointing to time scale indicators, the support member being aligned with the axis of rotation of the second celestial body representation.

15. The astronomical clock of claim 14, wherein the second celestial body representation includes an actuator pivotally connecting the second celestial body representation to the support member, the actuator being configured to rotate the second celestial body representation about its axis of rotation to simulate the rotation of the second celestial body.

16. The astronomical clock of claim 15, wherein the support member has an inclination representative of the inclination of the axis of rotation of the second celestial body with respect to the ellipsoid trajectory around the first celestial body.

17. The astronomical clock of claim 1, further comprising a controller operatively connected to the displacement mechanism, the controller being so configured so as to allow the setting of the astronomical clock at a desired time period.

18. The astronomical clock of claim 15, further comprising a controller operatively connected to the displacement mechanism and the actuator, the controller being so configured so as to allow the setting of the astronomical clock at a desired time period.

19. The astronomical clock of claim 18, wherein the controller includes a remote access interface allowing control of the astronomical clock from a remote controller.

20. The astronomical clock of claim 1, wherein the first celestial body is the Sun and the second celestial body if the Earth.
